(19) United States
(12) Patent Application Publication
(10) Pub. No.: US 2023/0222264 A1
(43) Pub. Date: Jul. 13, 2023

(54) PROCESSING CHAMBER CALIBRATION

(71) Applicant: APPLIED MATERIALS, INC., Santa Clara, CA (US)

(72) Inventors: Rohit Mahakali, Bangalore (IN); Elizabeth Kathryn Neville, Sunnyvale, CA (US); Adolph Miller Allen, Oakland, CA (US); Xiaoxiong Yuan, San Jose, CA (US); Weize Hu, Santa Clara, CA (US); Karthik Ramanathan, Bangalore (IN)

(21) Appl. No.: 17/571,370

(22) Filed: Jan. 7, 2022

(51) Int. Cl. G06F 30/27; H01L 21/67

(52) U.S. Cl. CPC G06F 30/27; H01L 21/67276; H01L 21/67155; H01L 21/67248

(57) ABSTRACT

A method includes receiving, from sensors, sensor data associated with processing a substrate via a processing chamber of substrate processing equipment. The sensor data includes a first subset received from one or more first sensors and a second subset received from one or more second sensors, the first subset being mapped to the second subset. The method further includes identifying model input data and model output data. The model output data is output from a physics-based model based on model input data. The method further includes training a machine learning model with data input including the first subset and the model input data, and target output data including the second subset and the model output data to tune calibration parameters of the machine learning model. The calibration parameters are to be used by the physics-based model to perform corrective actions associated with the processing chamber.

### TECHNICAL FIELD

The present disclosure relates to calibration, and more particularly to processing chamber calibration.

### BACKGROUND

Manufacturing equipment produce products. For example, substrate processing equipment produce substrates. Sensors are used to provide sensor data associated with manufacturing equipment. Parameters of the manufacturing equipment are selected based on sensor data.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one aspect of the disclosure, a method includes receiving, from a plurality of sensors, sensor data associated with processing a substrate via a processing chamber of substrate processing equipment. The sensor data includes a first subset received from one or more first sensors and a second subset received from one or more second sensors, the first subset being mapped to the second subset. The method further includes identifying model input data and model output data. The model output data is output from a physics-based model based on model input data. The method further includes training a machine learning model with data input including the first subset and the model input data, and target output data including the second subset and the model output data to tune one or more calibration parameters of the machine learning model. The one or more calibration parameters are to be used by the physics-based model to perform one or more corrective actions associated with the processing chamber.

In another aspect of the disclosure, a method includes identifying one or more calibration parameters tuned via training a machine learning model. The machine learning model is trained with data input including a first subset of sensor data and first model input data, and target output data including a second subset of the sensor data and first model output data. The sensor data is received from a plurality of sensors. The sensor data is associated with processing a substrate via a processing chamber of substrate processing equipment, and the first model output data is output from a physics-based model based on the first model input data. The method further includes identifying second model input data. The method further includes, responsive to providing the second model input data and the calibration parameters as input to the physics-based model, receiving, from the physics-based model, second model output data. One or more corrective actions associated with the processing chamber are to be performed based on the second model output data.

In another aspect of the disclosure, a non-transitory machine-readable storage medium stores instructions which, when executed cause a processing device to perform operations including receiving, from a plurality of sensors, sensor data associated with processing a substrate via a processing chamber of substrate processing equipment. The sensor data includes a first subset received from one or more first sensors and a second subset received from one or more second sensors, the first subset being mapped to the second subset. The processing device is further to identify model input data and model output data. The model output data is output from a physics-based model based on model input data. The processing device is further to train a machine learning model with data input including the first subset and the model input data, and target output data including the second subset and the model output data to tune one or more calibration parameters of the machine learning model. The one or more calibration parameters are to be used by the physics-based model to perform one or more corrective actions associated with the processing chamber.

### BRIEF DESCRIPTION OF THE DRAWINGS

The present disclosure is illustrated by way of example, and not by way of limitation in the figures of the accompanying drawings.

FIG. 1A is a block diagram illustrating an exemplary system (exemplary system architecture), according to certain embodiments.

FIG. 1B is a block diagram illustrating a flow of data related to tuning calibration parameter data, according to certain embodiments.

FIG. 2 is a block diagram of an example data set generator used to create data sets for a machine learning model, according to certain embodiments.

FIG. 3 is a block diagram illustrating system for generating calibration parameter data, according to certain embodiments.

FIGS. 4A-C are flow diagrams of methods associated with generating calibration parameter data to cause a corrective action, according to certain embodiments.

FIG. 5 is a block diagram illustrating a computer system, according to certain embodiments.

### DETAILED DESCRIPTION

Described herein are technologies directed to processing chamber calibration (e.g., methods to calibrate a processing chamber digital twin).

Manufacturing equipment is used to produce products. For example, substrate processing equipment produces substrates (e.g., semiconductors, wafers, etc.). Substrate processing equipment has manufacturing parameters, such as hardware parameters and/or process parameters that are used during substrate processing. For example, the manufacturing parameters of a particular temperature and pressure in a processing chamber may be used during substrate processing. Substrates that have been processed (or partially processed) have property data (e.g., thickness data, roughness data). Manufacturing parameters of the substrate processing equipment are adjusted to attempt to produce substrates that have property data that match threshold property data (e.g., good substrates).

Conventionally, models are created to attempt to mirror a processing chamber. Models are calibrated manually to attempt to determine manufacturing parameters to produce substrates that have property data that match threshold property data. Manual calibration takes a lot of time, trial and error, and is a waste of materials. Given the many different manufacturing parameters, many combinations of different values for the manufacturing parameters, and limits on time and material, non-ideal manufacturing parameters are often determined via manual calibration. Use of non-ideal manufacturing parameters results in faulty substrates, lower yield, and inefficient processing.

A model may be created based on guesses of relationships between first manufacturing parameters and second manufacturing parameters. For example, a model may be created based on a guess between a temperature and a guess of a resulting pressure. Then, sensor data from sensors associated with the processing chamber may be used to update the guesses of relationships between the manufacturing parameters. For example, measured temperature data from a temperature sensor and measured pressure data from a pressure sensor may be used to update the guess of a relationship between temperature data and resulting pressure data. A manufacturing parameter may result from many other manufacturing parameters, some of which may not be measured. Conventional models that are updated based on sensor data are not fully updated because of unmeasured manufacturing parameters that affect manufacturing parameters in the model. Non-ideal models lead to use of non-ideal manufacturing parameters which results in faulty substrates, lower yield, and inefficient processing.

Conventionally, a model is created and updated offline (when the processing chamber is not being used) and then the model is used throughout use of the processing chamber. As processing chambers are used repeatedly, relationships between different manufacturing parameters change (e.g., drift), due to material buildup, aging parts, alterations during cleaning procedures, and the like. For example, relationship between temperature and pressure in a processing chamber drift over time. Conventional models become more and more inaccurate over time due to drift. As the models become more and more inefficient, there are more faulty substrates, even lower yield, and less inefficient processing.

Conventionally, the same model may be used for different processing chambers. Processing chambers are produced within tolerance ranges, so that each processing chamber works somewhat differently. Different processing chambers age differently, causing different types of drift for each processing chamber. A conventional model used for many different processing chambers has different levels of accuracy for each processing chamber and leads to inconsistent substrates produced by the processing chambers, reduced yield, and reduced efficiency.

The methods, devices, and systems of the present disclosure provide solutions to deficiencies of conventional systems. This present disclosure provides processing chamber calibration (e.g., calibration of a processing chamber digital twin).

Sensor data is received from sensors. The sensors may be associated with a processing chamber (e.g., disposed in the processing chamber, provide sensor data of the processing chamber, etc.). For example, the sensors may provide temperature data, pressure data, flow rate data, etc. during the operation of the processing chamber (e.g., processing of a substrate).

The sensor data includes different subsets of sensor data received from different sensors. A first subset of the sensor data is received from one or more first sensors and a second subset of the sensor data is received from one or more second sensors, where the first subset is mapped to the second subset. In some embodiments, the first subset includes chamber pressure data, backside pressure data, heater temperature data, and gas flow rate data. Additionally, the first subset may include chamber component spacing data. The second subset may include chamber component temperature data.

Model input data and model output data are identified. The model input data is provided to a physics-based model and the physics-based model generates (e.g., predicts) the model output data based on the inputted model input data. In some embodiments, the model output data includes component temperature data associated with one or more components of the processing chamber.

The first subset of the sensor data and the model input data may correspond to one or more first types of data (e.g., same first types of data). The second subset of the sensor data and the model output data may correspond to one or more second types of data (e.g., same types of data) that are different from the first types of data. For example, the first subset of the sensor data and the model input data may both include spacing, chamber pressure, backside pressure, heater temperature, and/or gas flow rate. The second subset of the sensor data and the model output data may both include component temperatures.

A machine learning model may be trained with data input including the first subset of the sensor data and the model input data and target output data including the second subset of the sensor data and the model output data to tune calibration parameters of the machine learning model. Calibration parameters may include parameters that are not or cannot measured, such as thermal contact resistance, thermal contact conductance, etc. After the machine learning model tunes the calibration parameters, the calibration parameters may be used by the physics-based model to perform corrective actions associated with the processing chamber and generate more accurate predicted variables.

Model input data and the calibration parameters that have been tuned may be input into the physics-based model to generate updated model output data. Providing the tuned calibration parameters to the physics-based model may calibrate the physics-based model, providing a more accurate digital twin of the processing chamber. In some embodiments, the physics-based model is a digital twin model of the processing chamber. The updated model output data is more accurate than the initial model output data generated by the physics-based model using the initial prediction for the calibration parameters (i.e., the un-tuned calibration parameters). The updated model output data may be used to perform a corrective action associated with the processing chamber. For example, the corrective action may include one or more of providing an alert, interrupting operation of the processing chamber, or updating manufacturing parameters of the processing chamber.

Aspects of the present disclosure result in technological advantages compared to conventional systems. Using the aid of a machine learning model to tune calibration parameters of the physics-based model may save time when compared to the manual calibration of conventional models. There may no longer be a need for any manual calibration when using aspects of this disclosure. The calibration parameters, which under conventional methods may be difficult, impractical, or impossible to calculate manually, can be more easily and accurately predicted using the methods of this disclosure, leading to more accurate and precise models when compared to the models of conventional methods. Further, using this disclosure, a model can be created and updated online (when the processing chamber is being used), unlike conventional models which are created and updated offline. This disclosure also provides for the accounting of processing chamber drift, leading to more chamber-to-chamber consistency, which in turn leads to a more accurate model providing for fewer faulty substrates and higher yields, unlike the practices used conventionally. Additionally, the calibration parameters can be iterated upon using the methods of this disclosure, generating an increasingly accurate physics-based model over time when compared to conventional methods. Further, the methods of this disclosure may be able to compensate the physics-based model for chamber properties drift and for differences between individual chambers. The physics-based model of this disclosure is thus more dependable for performing corrective actions on the processing chamber, leading to more consistent and precise substrate manufacturing when compared to conventional methods.

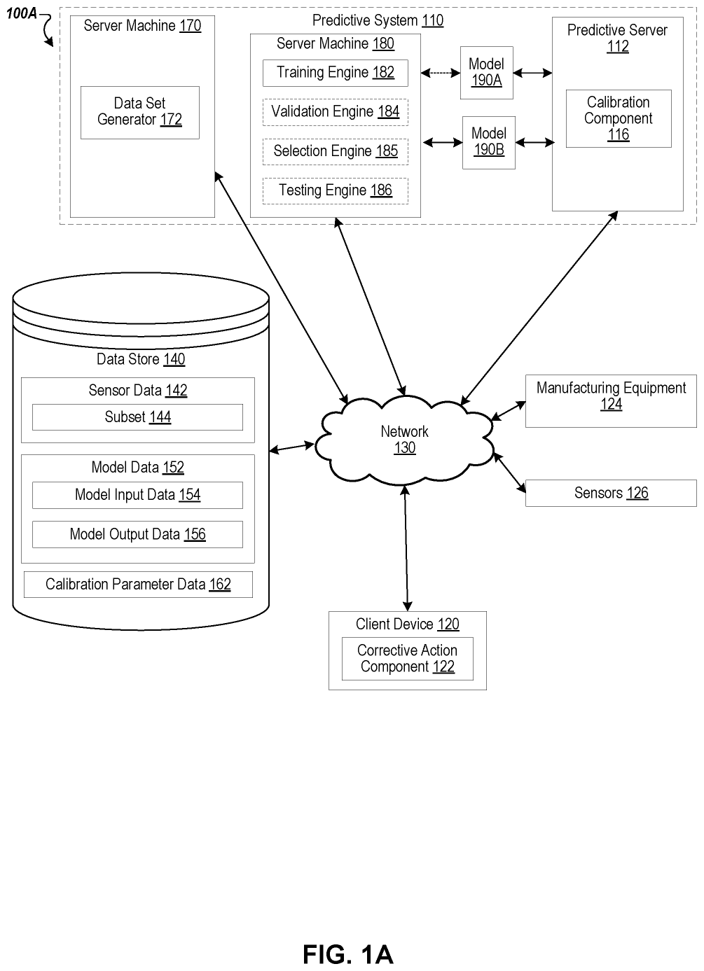

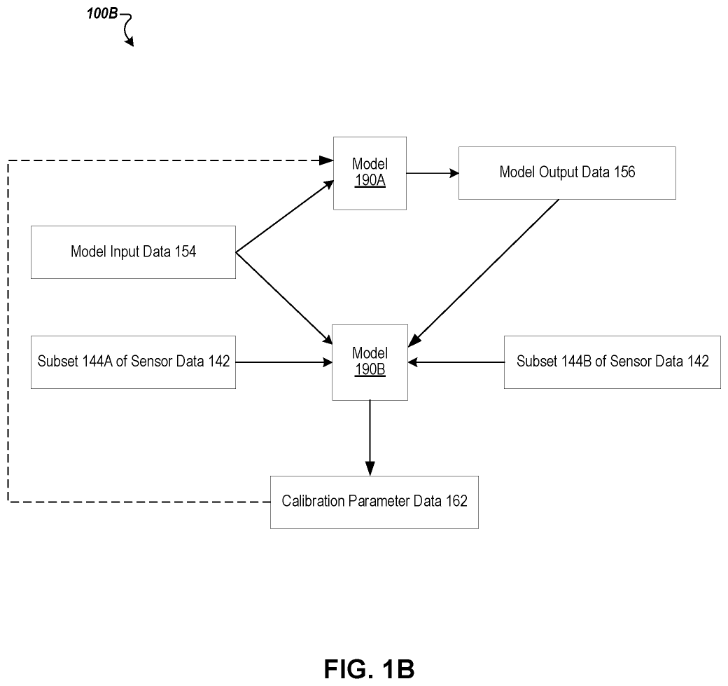

FIG. 1A is a block diagram illustrating an exemplary system 100A (exemplary system architecture), according to certain embodiments. The system 100 includes a client device 120, manufacturing equipment 124, sensors 126, a predictive server 112, and a data store 140. The predictive server 112 may be part of a predictive system 110. The predictive system 110 may further include server machines 170 and 180.

The sensors 126 may provide sensor data 142 associated with manufacturing equipment 124 (e.g., associated with producing, by manufacturing equipment 124, corresponding products, such as wafers, substrates, semiconductors, and/or displays). The sensor data 142 may be used for equipment health and/or product health (e.g., product quality), for example. The manufacturing equipment 124 may produce products following a recipe or performing runs over a period of time. In some embodiments, the sensor data 142 may include values of one or more of temperature (e.g., heater temperature, component temperature), spacing (SP), pressure (e.g., chamber pressure, backside pressure), High Frequency Radio Frequency (HFRF), voltage of Electrostatic Chuck (ESC), electrical current, flow (e.g., gas flow rate, flow of one or more gases), power, voltage, etc. Sensor data 142 may include one or more subsets 144 of sensor data 142 (e.g., a first subset 144 of sensor data 142 from a first subset of sensors 126 and a second subset 144 of sensor data 142 from a second subset of sensors 126). Sensor data 142 may be provided while the manufacturing equipment 124 is performing manufacturing processes (e.g., equipment readings when processing products). The sensor data 142 may be different for each product (e.g., each substrate). In some embodiments, sensor data 142 is obtained from an experimental run of a process operation in the processing chamber.

In some embodiments, the sensor data 142 may be processed (e.g., by the client device 120 and/or by the predictive server 112). Processing of the sensor data 142 may include generating features. In some embodiments, the features are a pattern in the sensor data 142 (e.g., slope, width, height, peak, etc.) or a combination of values from the sensor data 142 (e.g., power derived from voltage and current, etc.). The sensor data 142 may include features and the features may be used by the predictive system 110 for performing signal processing and/or for obtaining model input data 154, model output data 156, and/or calibration parameter data 162 to perform a corrective action.

Each instance (e.g., set) of sensor data 142 may correspond to a product (e.g., a substrate), a set of manufacturing equipment, a type of substrate produced by manufacturing equipment, a combination thereof, or the like. The data store 140 may further store information associating sets of different data types, e.g. information indicative that a set of sensor data 142, and/or a set of model data are all associated with the same product, manufacturing equipment, type of substrate, etc.

In some embodiments, the predictive system 110 may generate calibration parameter data 162 using supervised machine learning (e.g., model 190B trained based on input including a first subset 144 of sensor data 142 and model input data 154 and target output including model output data 156 and a second subset 144 of sensor data 142 to tune calibration parameter data 162). In some embodiments, the calibration parameter data 162 is used to calibrate a physics-based model (e.g., model 190A) of a processing chamber of manufacturing equipment 124. In some embodiments, the calibrated physics-based model is a digital twin model of the processing chamber of manufacturing equipment 124 that is used to perform a corrective action (e.g., update manufacturing parameters of the processing chamber). As used herein, a digital twin is a digital replica of a physical asset, such as a manufactured part (e.g., manufacturing equipment 124, processing chamber, substrate processing system, etc.). The digital twin includes characteristics of the physical asset at each stage of the manufacturing process, in which the characteristics include, but are not limited to, coordinate axis dimensions, weight characteristics, material characteristics (e.g., density, surface roughness), electrical characteristics (e.g., conductivity), optical characteristics (e.g., reflectivity), manufacturing parameters (e.g., hardware parameters, process parameters), etc.

The client device 120, manufacturing equipment 124, sensors 126, predictive server 112, data store 140, server machine 170, and server machine 180 may be coupled to each other via a network 130 for generating model output data 156 and/or calibration parameter data 162, optionally for performing corrective actions.

In some embodiments, network 130 is a public network that provides client device 120 with access to the predictive server 112, data store 140, and/or other publicly available computing devices. In some embodiments, network 130 is a private network that provides client device 120 access to manufacturing equipment 124, sensors 126, data store 140, and/or other privately available computing devices. In some embodiments, network 130 is a cloud-based network capable of performing cloud-based functionality (e.g., providing cloud service functionality to one or more devices in the system). Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

The client device 120 may include a computing device such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, cloud servers, cloud-based system (e.g., cloud service device, cloud network device), etc. The client device 120 may include a corrective action component 122. Corrective action component 122 may receive user input (e.g., via a Graphical User Interface (GUI) displayed via the client device 120) of an indication associated with manufacturing equipment 124. In some embodiments, the corrective action component 122 transmits the indication to the predictive system 110, receives output (e.g., model output data 156) from the predictive system 110, determines a corrective action based on the output, and causes the corrective action to be implemented.

In some embodiments, predictive system 110 may further include a calibration component 116. Calibration component 116 may use sensor data 142 and model data 152 (e.g., associated with a physics-based model 190A) to train a machine learning model 190B. In some embodiments, calibration component 116 provides model input data 154 to physics-based model 190A to generate model output data 156. Calibration component 116 may receive model data 152 associated with the physics-based model 190A and input at least a portion of model data 152 to machine learning model 190B. Calibration component 116 may receive calibration parameter data 162 from model 190B. In some embodiments, calibration component 116 provides calibration parameter data 162 and model input data 154 to model 190A and receives model output data 156 from model 190A. Calibration component 116 provides the model output data 156 to client device 120 and client device 120 causes a corrective action via corrective action component 122 in view of model output data 156. In some embodiments, the corrective action component 122 obtains sensor data 142 (e.g., subsets 144 of sensor data 142) associated with the manufacturing equipment 124 (e.g., from data store 140, etc.) and provides the sensor data 142 (e.g., subsets 144 of sensor data 142) associated with the manufacturing equipment 124 to the predictive system 110.

In some embodiments, the corrective action component 122 stores sensor data 142 in the data store 140 and the predictive server 112 retrieves the sensor data 142 from the data store 140. In some embodiments, the predictive server 112 may store output (e.g., model output data 156) of the trained machine learning model 190B in the data store 140 and the client device 120 may retrieve the output from the data store 140. In some embodiments, the corrective action component 122 receives an indication of a corrective action from the predictive system 110 and causes the corrective action to be implemented. In some embodiments, the corrective action includes updating manufacturing parameters (e.g., hardware parameters, process parameters) of manufacturing equipment 124 based on the model output data 156. Client device 120 may include an operating system that allows users to one or more of generate, view, or edit data (e.g., indication associated with manufacturing equipment 124, corrective actions associated with manufacturing equipment 124, etc.).

In some embodiments, the calibration parameter data 162 is associated with one or more values of the manufacturing equipment 124 that are not or cannot be measured (e.g., calibration parameters of the manufacturing equipment 124). In some embodiments, calibration parameters (e.g., calibration parameter data 162) include one or more of thermal contact conductance or thermal contact resistance of individual component contacts of the manufacturing equipment 124 (e.g., where components touch). The interfaces and/or contacts between two solid objects of the manufacturing equipment 124 creates thermal contact resistance (and thermal contact conductance) for heat flow between the two solid objects. In some embodiments, the calibration parameter data 162 is predicted calibration parameter values (e.g., predicted thermal contact resistance or predicted thermal contact conductance) of one or more components of the manufacturing equipment 124, based on sensor data 142 (e.g., current conditions of the manufacturing equipment 124) and/or model data 152 (e.g., predicted conditions of the manufacturing equipment 124). In some embodiments, the thermal contact resistance or thermal contact conductance is between one or more components of the processing chamber. For example, each pair of components that touch each other have an associated thermal contact conductance (e.g., time rate of steady state heat flow between components induced by a unit temperature difference) or thermal contact resistance (e.g., ratio of temperature drop and average heat flow across an interface). Some such thermal relationships may include a thermal contact conductance or thermal contact resistance of a contact (e.g., interface) between a showerhead and a lid of a processing chamber, between a heater and a shaft of a processing chamber, between a blocker plate and a lid of a processing chamber, between a blocker plate and the chamber sidewall of a processing chamber, etc. In some embodiments, the calibration parameter data 162 includes an indication of change over time or drift in some component of manufacturing equipment 124, sensors 126, and the like. In some embodiments, the calibration parameter data 162 is reflective of process conditions of the manufacturing equipment 124 (e.g., dependent upon temperature, pressure, etc. of a substrate processing operation). In some embodiments, the calibration parameter data 162 is used to calibrate a physics-based model (e.g., model 190A) of the processing chamber.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used to manufacture a product) and model data 152, tuning calibration parameter data 162, and performing a corrective action based on the calibration parameter data 162 (e.g., calibrating a physics-based model of the processing chamber), system 100 can have the technical advantage of avoiding the cost of producing, identifying, and discarding defective products by utilizing an accurate and calibrated physics-based model of the processing chamber.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting the sensor data 142 and model data 152 into the trained machine learning model 190B, tuning calibration parameter data 162, and performing (e.g., based on the calibration parameter data 162) a corrective action of updating manufacturing parameters (e.g., calibrating a physics-based model 190A of the processing chamber to update model data 152), system 100 can have the technical advantage of using optimal manufacturing parameters (e.g., hardware parameters, process parameters, optimal design) to avoid costly results of suboptimal manufacturing parameters by utilizing an accurate and calibrated physics-based model of the processing chamber.

Corrective action may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, calibration of a model (e.g., calibration of a physics-based model), or the like.

In some embodiments, the corrective action includes providing an alert (e.g., an alarm to stop or not perform the manufacturing process). In some embodiments, the corrective action includes providing feedback control (e.g., modifying a manufacturing parameter responsive to the calibration parameter data 162 and/or model output data 156). In some embodiments, the corrective action includes providing machine learning (e.g., modifying one or more manufacturing parameters based on the calibration parameter data 162). In some embodiments, performance of the corrective action includes causing updates to one or more manufacturing parameters. In some embodiments, the corrective action includes calibrating a physics-based model based on calibration parameter data 162.

Manufacturing parameters may include hardware parameters (e.g., replacing components, using certain components, replacing a processing chip, updating firmware, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., manufacturing equipment 124 to be in an idle mode, a sleep mode, a warm-up mode, etc.). In some embodiments, the corrective action includes updating a physics-based model.

The predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. The predictive server 112, server machine 170, and server machine 180 may each include a cloud server or a server capable of performing one or more cloud-based functions.

The predictive server 112 may include a calibration component 116. In some embodiments, the calibration component 116 receives sensor data 142 (e.g., subset 144 of sensor data 142) and model data 152 (e.g., model input data 154 and model output data 156) and generates output (e.g., calibration parameter data 162 and/or model output data 156) for performing corrective actions associated with the manufacturing equipment 124. In some embodiments, the calibration component 116 may use a trained machine learning model 190B to determine the output for performing the corrective action. In some embodiments, the calibration component 116 may use a physics-based model (e.g., model 190A) to determine at least a portion of the output for performing the corrective action.

In some embodiments, sensor data 142 and model data 152 is provided to train a machine learning model 190B. Machine learning model 190B is trained to tune calibration parameter data 162 to be used in a physics-based model of the processing chamber. In some embodiments, machine learning model 190B is trained based on input (e.g., sensor data 142) of spacing data, chamber pressure data, heater temperature data, and/or chamber flow rate data from sensors 126 disposed at locations within the processing chamber. In some embodiments, one or more sensors 126 are not located proximate the substrate. For example, temperature sensors may be disposed at various locations near gas intakes, exhaust conduits, substrate supports, chamber walls, and so on. Model 190B tunes calibration parameter data 162. In some embodiments, the calibration parameter data 162 includes thermal contact resistance or thermal contact conductance data at contact points between components of the processing chamber.

Combining machine learning model and physics-based modeling provides technical advantages over other techniques. A physics-based model provides a map of manufacturing parameters (e.g., of a processing chamber). Due to ranges of manufacturing tolerances, aging of components, etc., a conventional physics-based model may have inaccuracies (e.g., may not accurately model a processing chamber). For instance, a heater may supply slightly less or more energy than expected, a gas flow regulator may not allow precisely the flow rate chosen, contact between surfaces in a chamber may be somewhat less than ideal, and the like. Such variations may be unknown to the user, and may not be captured in a conventional physics-based model. By tuning calibration parameter data 162 using a machine learning model 190B (e.g., implementing a machine learning model performing virtual measurement of unmeasurable values, such as calibration parameter data 162 including thermal contact resistance values and/or thermal contact conductance values), the physics-based model 190A of the present disclosure is more accurate than conventional models. The machine learning model 190B is trained on a variety of input parameters (e.g., sensor data 142, model data 152), spanning a region of parameter space. Variations in actual conditions in the processing chamber (e.g., due to inaccuracies in an initial physics-based model) within the range of parameter space the machine learning model is trained to operate on can be accounted for via interpolation. Additionally, settings somewhat outside the region of parameter space used to train the machine learning model can be accounted for via extrapolation. In this way, unexpected variations in operating conditions of a processing chamber can be accounted for by using the calibration parameter data 162 provided by predictive system 110.

In some embodiments, calibration component 116 receives sensor data 142 (e.g., subset 144 of sensor data 142), and may perform pre-processing such as extracting patterns in the data or combining data to new composite data. In some embodiments, calibration component 116 receives model data 152 associated with a physics-based model (e.g., model input data 154 and model output data 156). Calibration component 116 may then provide the sensor data 142 and model data 152 to train machine learning model 190B. The machine learning model 190B may be trained with data input including a first subset 144 of sensor data 142 (e.g., subset 144A of sensor data 142 of FIG. 1B) and model input data 154 and target output data including a second subset 144 of sensor data 142 (e.g., subset 144B of sensor data 142 of FIG. 1B) and model output data 156. In some embodiments, the first subset 144A of sensor data 142 and the model input data 154 correspond to one or more first types of data. In some embodiments, the second subset 144B of the sensor data 142 and the model output data 156 correspond to one or more second types of data. In some embodiments, the one or more second types of data are different from the one or more first types of data. Calibration component 116 may receive, from trained machine learning model 190B, one or more calibration parameter values (e.g., calibration parameter data 162) associated with a physics-based model of the processing chamber (e.g., model 190A). Calibration component 116 may then cause a corrective action to occur. The corrective action may include sending an alert to client device 120. The corrective action may also include updating manufacturing parameters of manufacturing equipment 124. The corrective action may also include updating a physics-based model (e.g., model 190A) based on the calibration parameter data 162 (e.g., calibration parameter values).

Data store 140 may be a memory (e.g., random access memory), a drive (e.g., a hard drive, a flash drive), a database system, or another type of component or device capable of storing data. Data store 140 may be in-situ (e.g., a local computer) or may be remote (e.g., a cloud-based system). Data store 140 may include multiple storage components (e.g., multiple drives or multiple databases) that may span multiple computing devices (e.g., multiple server computers). The data store 140 may store sensor data 142, model data 152, and calibration parameter data 162.

Sensor data 142 may include one or more subsets of sensor data (e.g., subset 144 of sensor data 142). Sensor data may include trace data over the duration of manufacturing processes, associations of data with physical sensors, pre-processed data (e.g., averages and composite data), and data indicative of sensor performance over time (i.e., many manufacturing processes).

Model data 152 may contain features similar to those of sensor data 142.

Calibration parameter data 162 may be indicative of one or more calibration parameter values (e.g., calibration parameters) of a physics-based model 190A of a processing chamber of the manufacturing equipment 124. Calibration parameter data 162 may include predictions of calibration parameter values.

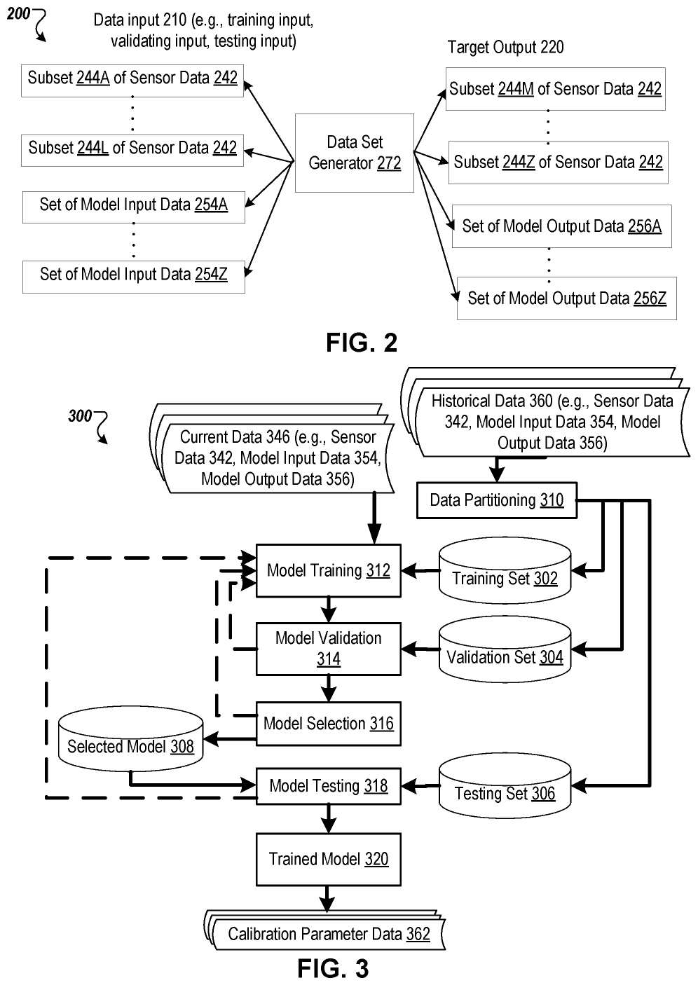

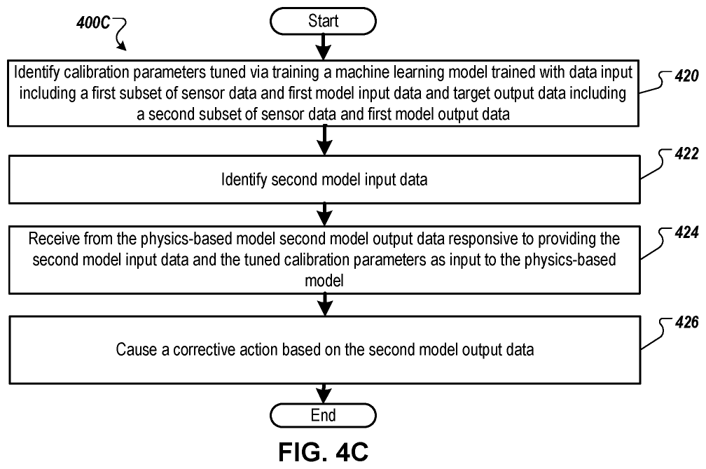

In some embodiments, predictive system 110 further includes server machine 170 and server machine 180. Server machine 170 includes a data set generator 172 that is capable of generating data sets (e.g., a set of data inputs and a set of target outputs) to train, validate, and/or test machine learning model 190B. Some operations of data set generator 172 are described in detail below with respect to FIGS. 2 and 4A. In some embodiments, the data set generator 172 may partition the sensor data (e.g., a subset 144 of sensor data 142) and model data (e.g., model input data 154 and model output data 156) into a training set (e.g., sixty percent of the data), a validating set (e.g., twenty percent of the data), and a testing set (e.g., twenty percent of the data). In some embodiments, the predictive system 110 (e.g., via calibration component 116) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a machine learning model 190B using one or more sets of features associated with the training set from data set generator 172. The training engine 182 may generate multiple trained machine learning models 190B, where each trained machine learning model 190B corresponds to a distinct set of features of the training set (e.g., sensor data from a distinct set of sensors). For example, a first trained machine learning model may have been trained using all features (e.g., X1-X5), a second trained machine learning model may have been trained using a first subset of the features (e.g., X1, X2, X4), and a third trained machine learning model may have been trained using a second subset of the features (e.g., X1, X3, X4, and X5) that may partially overlap the first subset of features. Data set generator 172 may receive the output of a trained machine learning model (e.g., model 190B), collect that data into training, validation, and testing data sets, and use the data sets to train a second machine learning model.

The validation engine 184 may be capable of validating a trained machine learning model 190B using a corresponding set of features of the validation set from data set generator 172. For example, a first trained machine learning model 190B that was trained using a first set of features of the training set may be validated using the first set of features of the validation set. The validation engine 184 may determine an accuracy of each of the trained machine learning models 190B based on the corresponding sets of features of the validation set. The validation engine 184 may discard trained machine learning models 190B that have an accuracy that does not meet a threshold accuracy. In some embodiments, the selection engine 185 may be capable of selecting one or more trained machine learning models 190B that have an accuracy that meets a threshold accuracy. In some embodiments, the selection engine 185 may be capable of selecting the trained machine learning model 190B that has the highest accuracy of the trained machine learning models 190B.

The testing engine 186 may be capable of testing a trained machine learning model 190B using a corresponding set of features of a testing set from data set generator 172. For example, a first trained machine learning model 190B that was trained using a first set of features of the training set may be tested using the first set of features of the testing set. The testing engine 186 may determine a trained machine learning model 190B that has the highest accuracy of all of the trained machine learning models based on the testing sets.

The machine learning model 190B may refer to the model artifact that is created by the training engine 182 using a training set that includes data inputs and corresponding target outputs (correct answers for respective training inputs). Patterns in the data sets can be found that map the data input to the target output (the correct answer), and the machine learning model 190B is provided mappings that captures these patterns. In some embodiments, the machine learning model 190B reconstructs calibration parameter values associated with a physics-based model of a processing chamber. The machine learning model 190B may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network), etc.

Calibration component 116 may provide model input data 154 to model 190A and receive model output data 156 from model 190A. Calibration component 116 may provide sensor data 142 and model data 152 to train machine learning model 190B to tune calibration parameter data 162. Calibration component 116 may provide model input data 154 and the calibration parameter data 162 to the model 190A and receive more accurate model output data 156 from the model 190A.

For purpose of illustration, rather than limitation, aspects of the disclosure describe the training of one or more machine learning models 190B using sensor data (e.g., sensor data 142) and model data (e.g., model data 152) to tune calibration parameter data 162. In other implementations, a heuristic model or rule-based model is used to tune calibration parameter data 162 (e.g., without using a trained machine learning model, by specifying the value of a parameter controlling the sparsity of a fit, etc.). Any of the information described with respect to data inputs 210 of FIG. 2 may be monitored or otherwise used in the heuristic or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the calibration parameter data 162. In another example, client device 120 may determine the calibration parameter data 162 based on the trained machine learning model (e.g., model 190B).

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, or the like.

Although embodiments of the disclosure are discussed in terms of generating calibration parameter data 162 to perform a corrective action in manufacturing facilities (e.g., semiconductor manufacturing facilities), embodiments may also be generally applied to improved data processing by utilizing physics-informed virtual measurements and calibration parameter data 162.

FIG. 1B is a block diagram illustrating a flow 100B of data related to tuning calibration parameter data 162 (e.g., to calibrate a physics-based model of a processing chamber), according to certain embodiments. In some embodiments, model 190A receives model input data 154. In some embodiments, model 190A is a physics-based model of a processing chamber. Model input data 154 may be input parameters of the physics-based model. In some embodiments, model input data 154 is for a whole operating space of a processing chamber. For example, model input data 154 may include set of parameters covering an entire range of operation of the processing chamber, such as a full range of spacing parameters, a full range of chamber pressure parameters, a full range of backside pressure parameters, a full range of heater temperature parameters, and/or a full range of gas flow rate parameters. The model input data 154 may include a substantial portion of combinations of input parameters associated with the processing chamber. In some embodiments, the model input data 154 includes manufacturing parameters to be used for a substrate processing recipe.

Responsive to receiving input, model 190A generates model output data 156. In some embodiments, model output data 156 is associated with the processing chamber. For example, in some embodiments, model output data 156 includes one or more modeled temperature values of one or more components of the processing chamber based on the model input data 154. In some embodiments, model output data 156 includes a set of modeled temperature values for each set of model input data 154 (e.g., input parameters) input to model 190A.

Initially, the model output data 156 from the physics-based model 190A may be inaccurate. In some embodiments, the physics-based model 190A uses calibration parameter data 162 (e.g., one or more calibration parameter values) which has not been tuned (e.g., or has not been further tuned) to produce model output data 156. The accuracy of the physics-based model 190A is increased by tuning the calibration parameter data 162 (e.g., one or more calibration parameters).

Model input data 154 and a subset 144A of sensor data 142 are provided as training input and model output data 156 and subset 144B of sensor data 142 are provided as target output to model 190B (e.g., to an untrained machine learning model, to a trained machine learning model that is to be further trained). Model 190B is trained to tune calibration parameter data 162 (e.g., to generate one or more tuned calibration parameters). In some embodiments, model input data 154 and model output data 156 are provided to the untrained machine learning model by calibration component 116 (see FIG. 1A). Additionally, a first subset of sensor data (e.g., subset 144A of sensor data 142) and a second subset of sensor data (e.g., subset 144B of sensor data 142) are provided to the untrained machine learning model (e.g., by calibration component 116).

In some embodiments, after the machine learning model 190B is trained, calibration parameter data 162 (e.g., one or more tuned calibration parameters) are retrieved from the trained machine learning model 190B. The calibration parameter data 162 (e.g., tuned calibration parameters) and the model input data 154 are provided as input to the physics-based model 190A. In some embodiments, the physics-based model 190A is updated based on the tuned calibration parameters. The accuracy of the physics-based model 190A is increased based on the calibration parameter data 162. Providing the tuned calibration parameters to the physics-based model (e.g., model 190A) allows more accurate modeling of the processing chamber. In some embodiments, providing tuned calibration parameters to the physics-based model generates a more accurate digital twin of the processing chamber.

FIG. 2 is a block diagram of an example data set generator 272 (e.g., data set generator 172 of FIG. 1A), used to create data sets for a machine learning model (e.g., model 190B of FIG. 1A), according to certain embodiments. A data set generator 272 may be part of server machine 170 of FIG. 1A. In some embodiments, system 100 of FIG. 1A includes multiple machine learning models. In such cases, each model may have a separate data set generator, or models may share a data set generator.

Referring to FIG. 2, system 200 containing data set generator 272 (e.g., data set generator 172 of FIG. 1A) creates data sets for a machine learning model (e.g., model 190B of FIG. 1A). Data set generator 272 may create data sets using sensor data and model data of a physics-based model (e.g., model 190A of FIG. 1A). In some embodiments, data set generator 272 creates training input by choosing a subset of model input data and model output data in a physics-based model (e.g., subset of model data 152 of FIG. 1A). For example, the output of the physics-based model may be predicted temperature values of components within the processing chamber.

Data set generator 272 may form a training set based on sensor data and model input data. In some embodiments, data input 210 includes actual data (e.g., sensor data) and simulated data (e.g., representing sensor data that could be received from sensors). The data input may include subsets 244A-L of sensor data 242 and sets of model input data 254A-Z. Data set generator 272 also generates target output 220 for training a machine learning model. Target output includes subsets 244M-Z of sensor data 242 and sets of model output data 256A-Z output from a physics-based model of the processing chamber. In some implementations, target output 220 includes a set of data output (e.g., model output data) from a physics-based model indicative of a prediction of the physics-based model based on one or more inputs (e.g., model input data) to the model. The set of data output from the physics-based model may include predicted component temperature values for each component of the processing chamber of interest. Data input 210 and target outputs 220 are supplied to a machine learning model (e.g., model 190B of FIG. 1A).

Referring to FIG. 2, in some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. Data inputs 210 may also be referred to as “features,” “attributes,” or “information.” In some embodiments, data set generator 272 may provide the data set to the training engine 182, validating engine 184, or testing engine 186 of FIG. 1A, where the data set is used to train, validate, or test machine learning model 190B of FIG. 1A. Some embodiments of generating a training set may further be described with respect to FIG. 4A.

In some embodiments, data set generator 272 may generate a first data input corresponding to a first subset 244A of sensor data 242 and a first set of model input data 254A to train, validate, or test a first machine learning model and the data set generator 272 may generate a second data input corresponding to a second subset 244B of sensor data 242 second set of model input data 254B to train, validate, or test a second machine learning model.

In some embodiments, data set generator 272 may perform operations on one or more of data input 210 and target output 220. Data set generator 272 may extract patterns from the data (slope, curvature, etc.), may combine data (average, feature production, etc.), or may separate simulated sensors into groups to train separate models.

Data inputs 210 and target outputs 220 to train, validate, or test a machine learning model may include information for a particular processing chamber (e.g., a particular substrate processing chamber). Data inputs 210 and target outputs 220 may include information for a particular processing chamber design (e.g., used for all processing chambers of that design).

In some embodiments, the information used to train the machine learning model may be from specific types of manufacturing equipment (e.g., manufacturing equipment 124 of FIG. 1A) of the manufacturing facility having specific characteristics and allow the trained machine learning model to determine outcomes for a specific group of manufacturing equipment 124 based on sensor data and/or model data associated with one or more components sharing characteristics of the specific group. In some embodiments, the information used to train the machine learning model may be for components from two or more manufacturing facilities and may allow the trained machine learning model to determine outcomes for components based on input from one manufacturing facility.

In some embodiments, subsequent to generating a data set and training, validating, or testing a machine learning model using the data set, the machine learning model may be further trained, validated, or tested, or adjusted.

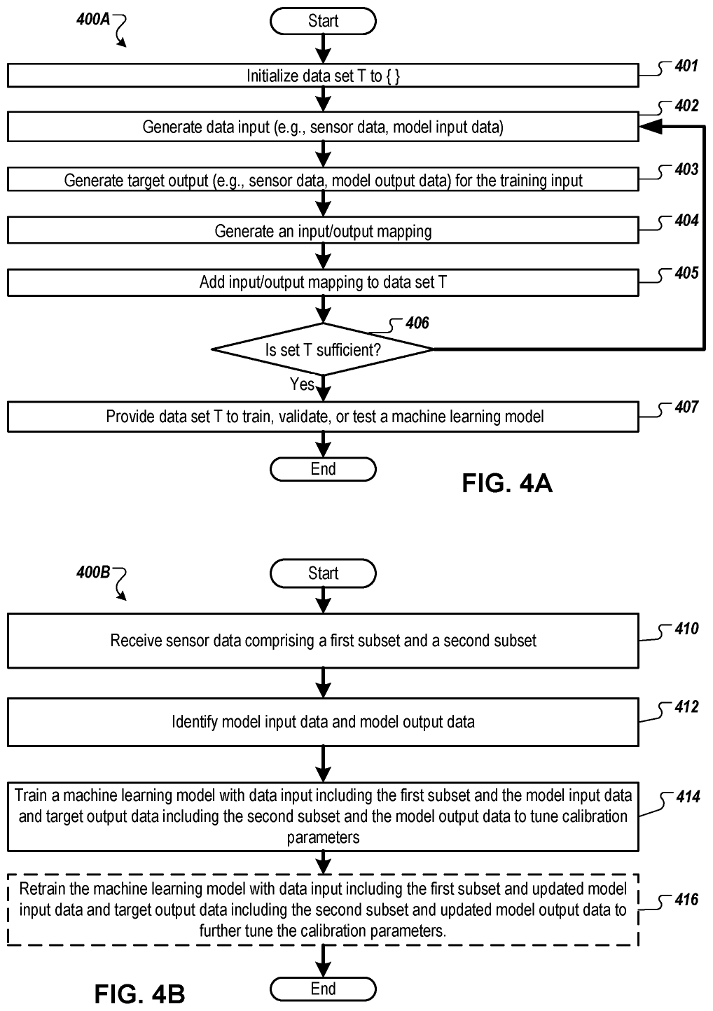

FIG. 3 is a block diagram illustrating system 300 for generating calibration parameter data 362 (e.g., calibration parameter data 162 of FIG. 1A), according to certain embodiments. System 300 may be used to tune calibration parameter data 362 to perform a corrective action using input from sensors and modeling techniques (e.g., physics-based modeling, and/or machine learning modeling).

Referring to FIG. 3, at block 310, the system 300 (e.g., components of predictive system 110 of FIG. 1A) performs data partitioning (e.g., via data set generator 172 of server machine 170 of FIG. 1A) of historical data 360 to generate the training set 302, validation set 304, and testing set 306. For example, the training set may be 60% of the simulated data, the validation set may be 20% of the simulated data, and the testing set may be 20% of the simulated data. Historical data 360 may include sensor data 342 (e.g., sensor data 142 of FIG. 1A), model input data 354 (e.g., model input data 154 of FIG. 1A), and model output data 356 (e.g., model output data 156 of FIG. 1A).

At block 312, the system 300 performs model training (e.g., via training engine 182 of FIG. 1A) using the training set 302. The system 300 may train multiple models using multiple sets of features of the training set 302 (e.g., a first set of features including a group of simulated sensors of the training set 302, a second set of features including a different group of simulated sensors of the training set 302, etc.). For example, system 300 may train a machine learning model to generate a first trained machine learning model using the first set of features in the training set and to generate a second trained machine learning model using the second set of features in the training set (e.g., different data than the data used to train the first machine learning model). In some embodiments, the first trained machine learning model and the second trained machine learning model may be combined to generate a third trained machine learning model (e.g., which may be a better predictor than the first or the second trained machine learning model on its own). In some embodiments, sets of features used in comparing models may overlap (e.g., one model may be trained with simulated sensors 1-15, and a second model trained with simulated sensors 10-20). In some embodiments, hundreds of models may be generated including models with various permutations of features and combinations of models.

At block 314, the system 300 performs model validation (e.g., via validation engine 184 of FIG. 1A) using the validation set 304. System 300 may validate each of the trained models using a corresponding set of features of the validation set 304. For instance, validation set 304 may use the same subset of simulated sensors used in training set 302, but for different input conditions. In some embodiments, the system 300 may validate hundreds of models (e.g., models with various permutations of features, combinations of models, etc.) generated at block 312. At block 314, the system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. The system 300 may discard the trained machine learning models that have an accuracy that is below the threshold accuracy (e.g., based on the validation set).

At block 316, the system 300 performs model selection (e.g., via selection engine 185 of FIG. 1A) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318 system 300 performs model testing (e.g., via testing engine 186 of FIG. 1A) using the testing set 306 to test the selected model 308. The system 300 may test, using the first set of features in the testing set (e.g., simulated sensors 1-15), the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 30A performs model training (e.g., retraining) using different training sets that may correspond to different sets of features or a reorganization of substrates split into training, validation, and testing sets. Responsive to determining that the selected model 308 has an accuracy that meets a threshold accuracy based on the testing set 306, flow continues to block 320. In at least block 312, the model may learn patterns in the simulated sensor data to make predictions and in block 318, the system 300 may apply the model on the remaining data (e.g., testing set 306) to test the predictions.

At block 320, system 300 determines calibration parameter data 362 from the trained model 320 (e.g., selected model 308). The training of model 320 tunes the calibration parameter data 362. The tuned calibration parameter data 362 may be used to perform an action (e.g., perform a corrective action in association with manufacturing equipment 124 of FIG., provide and alert to client device 120 of FIG. 1A, update a physics-based model, etc.).

The calibration parameter data 362 and model input data 354 are provided to a physics-based model (e.g., model 190A of FIG. 1A) to generate model output data 156. Current data 346 may include sensor data 342, model input data 354, and updated model output data 356 generated based on the model input data 354 and the tuned calibration parameter data 362.

In some embodiments, retraining of the machine learning model occurs by supplying additional data (e.g., current data 346) to further train the model. Current data 346 may be provided at block 312. Current data 346 may be different from the historical data 360 originally used to train the model by incorporating combinations of input parameters not part of the original training, input parameters outside the parameter space spanned by the original training, or may be updated to reflect chamber specific knowledge (e.g., differences from an ideal chamber due to manufacturing tolerance ranges, aging components, etc.). Selected model 308 may be retrained based on this data. In some embodiments, the selected model 308 is retrained or further trained until change of calibration parameter data 362 responsive to training of the selected model 308 meets a threshold change (e.g., is less than a threshold amount of change).

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIGS. 4A-C are flow diagrams of methods 400A-C associated with generating calibration parameter data to cause a corrective action, according to certain embodiments. Methods 400A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-C may be performed, in part, by predictive system 110 of FIG. 1A. Method 400A may be performed, in part, by predictive system 110 of (e.g., server machine 170 and data set generator 172 of FIG. 1A, data set generator 272 of FIG. 2). Predictive system 110 may use method 400A to generate a data set to at least one of train, validate, or test a machine learning model, in accordance with embodiments of the disclosure. Method 400B may be performed by server machine 180 (e.g., training engine 182, etc.). Method 400C may be performed by predictive server 112 (e.g., calibration component 116). In some embodiments, a non-transitory storage medium stores instructions that when executed by a processing device (e.g., of predictive system 110, of server machine 180, of predictive server 112, etc.) cause the processing device to perform one or more of methods 400A-C.

For simplicity of explanation, methods 400A-C are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for generating a data set for a machine learning model for generating calibration parameter data (e.g., calibration parameter data 162 of FIG. 1A), according to certain embodiments.

Referring to FIG. 4A, in some embodiments, at block 401 the processing logic implementing method 400A initializes a training set T to an empty set.

At block 402, processing logic generates first data input (e.g., first training input, first validating input) that may include a first subset of sensor data (e.g., subset 144A of sensor data 142 of FIG. 1B) and model input data (e.g., set of model input data 154 of FIG. 1B). In some embodiments, the first data input may include a first set of features for types of data and a second data input may include a second set of features for types of data (e.g., as described with respect to FIG. 3).

At block 403, processing logic generates a first target output for one or more of the data inputs (e.g., first data input). In some embodiments, the first target output includes a second subset of sensor data (e.g., subset 244B of sensor data 142 of FIG. 1B) and model output data (e.g., model output data 156 of FIG. 1B). The model output data may be output of a physics-based model (e.g., model 190A of FIG. 1B) based on input of model input data 154.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output.

At block 405, processing logic adds the mapping data generated at block 404 to data set T, in some embodiments.

At block 406, processing logic branches based on whether data set T is sufficient for at least one of training, validating, and/or testing machine learning model 190 of FIG. 1A. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other implementations, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180 of FIG. 1A) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. After block 407, machine learning model (e.g., machine learning model 190B) can be at least one of trained using training engine 182 of server machine 180, validated using validating engine 184 of server machine 180, or tested using testing engine 186 of server machine 180. The trained machine learning model may be implemented by calibration component 116 (of predictive server 112) to tune calibration parameter data 162 to perform a corrective action associated with the manufacturing equipment 124.

FIG. 4B is a method 400B for training a machine learning model (e.g., model 190B of FIG. 1A) to tune calibration parameter data to cause performance of a corrective action, according to certain embodiments.

Referring to FIG. 4B, at block 410 of method 400B, the processing logic receives sensor data from one or more sensors of a processing chamber of manufacturing equipment (e.g., sensors 126 of manufacturing equipment 124). The sensor data may include sensor values associated with the processing chamber during a manufacturing process for a particular arrangement of manufacturing parameters (e.g., recipe parameters, processing parameters, hardware settings, etc.). For example, the sensor data may be collected during an experimental run of a process operation in the processing chamber. The sensor data may include a first subset and a second subset, the first subset being mapped to the second subset. In some embodiments, the first subset of the sensor data includes one or more of spacing data, chamber pressure data, heater temperature data, or chamber flow rate data. In some embodiments, the second subset includes component temperature data associated with one or more components of the processing chamber.

At block 412, the processing logic identifies model input data and model output data, the model output data being output from a physics-based model. In some embodiments, the model input data and model output data (e.g., model input data 154 and model output data 156 of FIG. 1A) are associated with a physics-based model of the processing chamber (e.g., model 190A of FIG. 1A). In some embodiments, model input data is a set of inputs to the physics-based model representative an operating space of the processing chamber. For example, the model input data may substantially represent the range of input parameter values (e.g., temperature, pressure, etc.) for the processing chamber. As another example, the model input data may represent a design of experiments (DOE) corresponding to the physics-based model, where the variables of the DOE are one or more input parameters of the physics-based model. In some embodiments, model output data is a set of outputs of the physics-based model, each output corresponding to an input. For example, the model output data is a database of results from performing the DOE corresponding to the physics-based model. In some embodiments, the model output data is output from a physics-based model of the processing chamber. The model output data is mapped to the model input data. In some embodiments, the physics-based model initially utilizes calibration parameters that are not yet tuned. Tuning the calibration parameters increases the accuracy of the physics-based model. In some embodiments, the calibration parameters are one or more of predicted thermal contact resistance values or predicted thermal contact conductance values between corresponding components of the processing chamber.

At block 414, the processing logic trains a machine learning model. The machine learning model is trained with data input including the first subset of sensor data and the model input data. The machine learning model is trained with target output data including the second subset of the sensor data and the model output data. The training of the machine learning model is to tune one or more calibration parameters (e.g., calibration parameter data 162 of FIGS. 1A-B) associated with the physics-based model. Prior to training the machine learning model, a range of values may be assigned to the one or more calibration parameters. In some embodiments, tuning of the one or more calibration parameters includes adjusting corresponding values of the one or more calibration parameters within the range of values. In some embodiments, a user (e.g., a human user) assigns the range of values associated with the calibration parameters. In some embodiments, a processing device assigns the range of values associated with the calibration parameters. In some embodiments, the calibration parameters are included in calibration parameter data 162 of FIG. 1A. In some embodiments, the tuned calibration parameters are determined based on an algorithm of the machine learning model. The tuned calibration parameters are provided to the physics-based model. In some embodiments, the physics-based model is updated based on the tuned calibration parameters. Updating the physics-based model based on the tuned calibration parameters may cause the physics-based model to become a more accurate representation of the processing chamber and better predict behavior of the processing chamber.

At block 416, the machine learning model may be retrained or further trained with data input including the first subset of the sensor data and updated model input data and target output data including the second subset of the sensor data and updated model output data to further tune the calibration parameters. In some embodiments, the updated model input data and the updated model output data are associated with the updated physics-based model (e.g., updated physics-based model based on the tuned calibration parameters). Retraining the machine learning model may further tune the calibration parameters. In some embodiments, the further tuned calibration parameters are provided to the physics-based model. The physics-based model is further updated based on the further tuned calibration parameters. Further updating the physics-based model may cause the physics-based model to further become a more accurate representation of the processing chamber and better predict behavior of the processing chamber.

FIG. 4C is a method 400C for using calibration parameter data tuned via a trained machine learning model (e.g., model 190 of FIG. 1A), according to certain embodiments.

Referring to FIG. 4C, at block 420 of method 400C, the processing logic identifies calibration parameters tuned via training a machine learning model (e.g., trained via block 414 of FIG. 4B). The tuned calibration parameters and model input data are provided to the physics-based model to output updated model output data (e.g., the physics-based model is updated based on the tuned calibration parameters). In some embodiments, the machine learning model is trained according to the methods described in connection with FIG. 4B.

At block 422, the proceeding logic identifies second model input data. In some embodiments, the second model input data represents a set of input parameters (e.g., one or more of spacing parameters, chamber pressure parameters, backside pressure parameters, heater temperature parameters, gas flow rate parameters, etc.) to be input to the physics-based model. In some embodiments, the second model input data is to be input into the updated physics-based model to calculate one or more outputs. In some embodiments, the second model input data is provided by a user (e.g., a human user). In some embodiments, the second model input data is to be provided to the physics-based model after the physics-based model has been updated with tuned calibration parameters.

At block 424, the processing logic receives second model output data from the physics-based model. The receiving of the second model output data is responsive to providing the second model input data and the tuned calibration parameters as input to the physics-based model. In some embodiments, the physics-based model is updated based on the tuned calibration parameters, responsive to the calibration parameters being provided. In some embodiments, the second model output data is generated by the physics-based model subsequent to the physics-based model being updated based on the tuned calibration parameters.

At block 426, the processing logic causes one or more corrective actions based on the second model output data. In some embodiments, the one or more corrective actions are associated with the processing chamber. In some embodiments, the corrective action includes providing an alert, interrupting the manufacturing equipment, updating manufacturing parameters, etc.

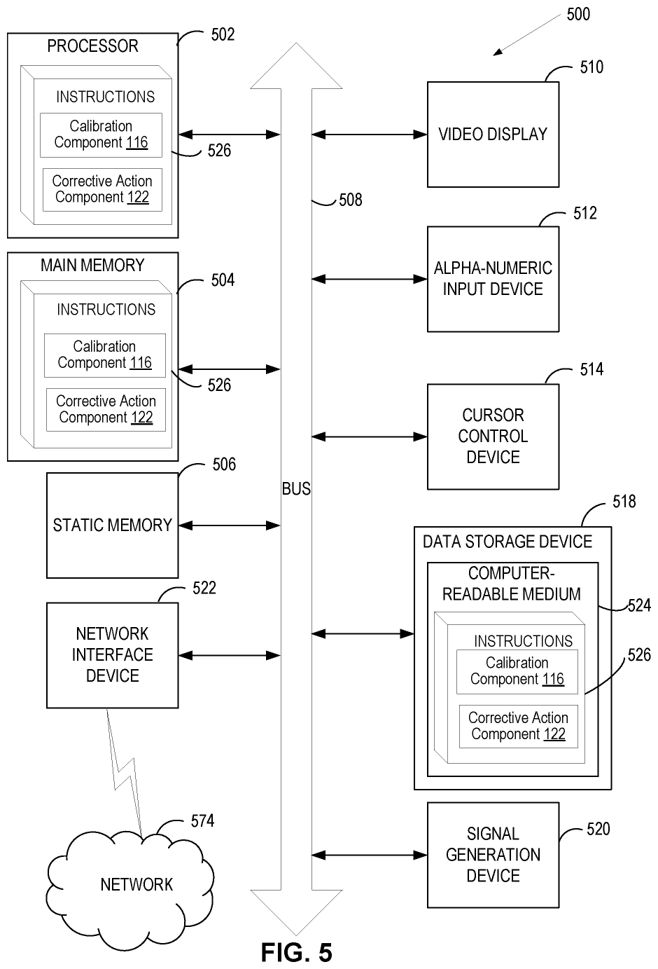

FIG. 5 is a block diagram illustrating a computer system 500, according to certain embodiments. In some embodiments, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein. Computer system 500 may include one or more of client device 120, predictive server 112, server machine 170, server machine 180, etc.

In a further aspect, the computer system 500 may include a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which may communicate with each other via a bus 508.

Processing device 502 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 500 may further include a network interface device 522 (e.g., coupled to network 574). Computer system 500 also may include a video display unit 510 (e.g., an LCD), an alphanumeric input device 512 (e.g., a keyboard), a cursor control device 514 (e.g., a mouse), and a signal generation device 520.

In some implementations, data storage device 518 may include a non-transitory computer-readable storage medium 524 (e.g., non-transitory machine-readable storage medium) on which may store instructions 526 (e.g., non-transitory machine-readable storage medium storing instructions) encoding any one or more of the methods or functions described herein, including instructions encoding components of FIG. 1A (e.g., calibration component 116, models 190A-B, etc.) and for implementing methods described herein.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,”, “identifying”, “training,” “interrupting,” “updating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
receiving, from a plurality of sensors, sensor data associated with processing a substrate via a processing chamber of substrate processing equipment, wherein the sensor data comprises a first subset received from one or more first sensors and a second subset received from one or more second sensors, the first subset being mapped to the second subset;
identifying model input data and model output data, the model output data being output from a physics-based model based on model input data; and
training a machine learning model with data input comprising the first subset and the model input data and target output data comprising the second subset and the model output data to tune one or more calibration parameters of the machine learning model, wherein the one or more calibration parameters are to be used by the physics-based model to perform one or more corrective actions associated with the processing chamber.

2. The method of claim 1, wherein:
the first subset of the sensor data comprises one or more of spacing data, chamber pressure data, heater temperature data, or chamber flow rate data; and
the second subset of the sensor data comprises component temperature data associated with one or more components of the processing chamber.

3. The method of claim 1, wherein the first subset of the sensor data and the model input data correspond to one or more first types of data, and wherein the second subset of the sensor data and the model output data correspond to one or more second types of data that are different from the one or more first types of data.

4. The method of claim 1, wherein the calibration parameters comprise one or more of predicted thermal contact resistance values or predicted thermal contact conductance values between corresponding components of the processing chamber.

5. The method of claim 1, wherein the physics-based model comprises a digital twin model that is used to update processing parameters of the processing chamber.

6. The method of claim 1, wherein responsive to the one or more calibration parameters being tuned, the model input data and the one or more calibration parameters are input to the physics-based model to generate updated model output data, wherein the updated model output data is used to perform the one or more corrective actions.

7. The method of claim 1, wherein the one or more corrective actions comprise one or more of:
providing an alert;
interrupting operation of the processing chamber; or
updating manufacturing parameters of the processing chamber.

8. The method of claim 1 further comprising assigning a range of values to the one or more calibration parameters prior to training the machine learning model, wherein tuning of the one or more calibration parameters comprises adjusting corresponding values of the one or more calibration parameters within the range of values.

9. A method comprising:
identifying one or more calibration parameters tuned via training a machine learning model, the machine learning model being trained with data input comprising a first subset of sensor data and first model input data and target output data comprising a second subset of the sensor data and first model output data, the sensor data being received from a plurality of sensors, the sensor data being associated with processing a substrate via a processing chamber of substrate processing equipment, and the first model output data being output from a physics-based model based on the first model input data;
identifying second model input data; and
responsive to providing the second model input data and the calibration parameters as input to the physics-based model, receiving, from the physics-based model, second model output data, wherein one or more corrective actions associated with the processing chamber are to be performed based on the second model output data.

10. The method of claim 9, wherein:
the first subset of the sensor data comprises one or more of spacing data, chamber pressure data, heater temperature data, or chamber flow rate data; and
the second subset of the sensor data comprises component temperature data associated with one or more components of the processing chamber.

11. The method of claim 9, wherein the first subset of the sensor data and the first model input data correspond to one or more first types of data, and wherein the second subset of the sensor data and the first model output data correspond to one or more second types of data that are different from the one or more first types of data.

12. The method of claim 9, wherein the calibration parameters comprise one or more predicted thermal contact resistance values or predicted thermal contact conductance values between corresponding components of the processing chamber.

13. The method of claim 9, wherein the physics-based model comprises a digital twin model that is used to update processing parameters of the processing chamber.

14. The method of claim 9, wherein responsive to the one or more calibration parameters being tuned, the first model input data and the one or more calibration parameters are input to the physics-based model to generate updated model output data, wherein the one or more corrective actions are performed based on the updated model output data.

15. The method of claim 9, wherein the one or more corrective actions comprise one or more of:
providing an alert;
interrupting operation of the processing chamber; or
updating manufacturing parameters of the processing chamber.

16. A non-transitory machine-readable storage medium storing instructions which, when executed cause a processing device to perform operations comprising:
receiving, from a plurality of sensors, sensor data associated with processing a substrate via a processing chamber of substrate processing equipment, wherein the sensor data comprises a first subset received form one or more first sensors and a second subset received from one or more second sensors, the first subset being mapped to the second subset;
identifying model input data and model output data, the model output data being output from a physics-based model based on model input data; and
training a machine learning model with data input comprising the first subset and the model input data and target output data comprising the second subset and the model output data to tune one or more calibration parameters of the machine learning model, wherein the one or more calibration parameters are to be used by the physics-based model to perform one or more corrective actions associated with the processing chamber.

17. The non-transitory machine-readable storage medium of claim 16, wherein the first subset of the sensor data and the model input data correspond to one or more first types of data, and wherein the second subset of the sensor data and the model output data correspond to one or more second types of data that are different from the one or more first types of data.

18. The non-transitory machine-readable storage medium of claim 16, wherein the physics-based model comprises a digital twin model that is used to update processing parameters of the processing chamber.

19. The non-transitory machine-readable storage medium of claim 16, wherein responsive to the one or more calibration parameters being tuned, the model input data and the one or more calibration parameters are input to the physics-based model to generate updated model output data, wherein the one or more corrective actions are performed based on the updated model output data.

20. The non-transitory machine-readable storage medium of claim 16, wherein the processing device is to further assign a range of values to the one or more calibration parameters prior to training the machine learning model, wherein tuning of the one or more calibration parameters comprises adjusting corresponding values of the one or more calibration parameters within the range of values.
